(19) United States
(12) Patent Application Publication
(10) Pub. No.: US 2006/0187206 A1
(43) Pub. Date: Aug. 24, 2006

(54) Computer mouse

(76) Inventor: Lin Jia Jing, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,363

(22) Filed: Feb. 18, 2005

(51) Int. Cl. G09G 5/08

(52) U.S. Cl. 345/163

(57) ABSTRACT

A computer mouse includes a body having a bottom and a top cover mounted to the bottom to define therebetween an interior space for accommodating mechanical/electronic/optic components. The cover has front and rear portions separated by a partition wall. The front portions forms control buttons of the mouse. The rear portion has a surface from which pegs extend. A soft pad has a bottom defining holes fit over the pegs to fix the pad on the surface of the rear portion of the cover of the mouse.

### BACKGROUND OF THE INVENTION

1. Field of the Invention

The present invention relates generally to a computer mouse, and in particular to a computer mouse having a soft pad mounted to a top cover thereof for comfortable gripping and ergonomics.

2. The Related Art

A computer mouse is one of the most important input devices of a computer system. Researches indicate that a rigid and small mouse may cause more serious damage to a user's wrist than a soft and large mouse does. Conventionally, the computer mouse comprises a flat bottom for movement on for example a desk and a rigid top cover mounted to the bottom to accommodate therebetween mechanical/electronic/optic components of the mouse. For easy manufacturing, both the bottom and cover of the computer mouse are heretofore made of rigid materials, such as solid plastics, which as indicated in related researches, may easily cause damage to the user's wrist, especially for long term use.

It is thus desirable to provide a computer mouse that has an ergonomic design and overcomes the problem of damaging user's health by the conventional designs of computer mouse.

### SUMMARY OF THE INVENTION

Therefore, a primary objective of the present invention is to provide a computer mouse that is of ergonomic construction so as not to damage user's body health.

Another objective of the present invention is to provide a computer mouse that comprises a soft pad mounted on a top cover thereof to provide a comfortable and ergonomic contact by a user's palm.

A further object of the present invention is to provide a computer mouse in which a vibrator is embedded for massaging the user's palm and wrist when the user holding the mouse.

To achieve the above objectives, in accordance with the present invention, a computer mouse comprises a mouse body on which a soft pad is attached. The mouse body has a functional construction similar to a regular computer mouse, comprising a top cover mounted to a bottom to define an interior space therebetween for accommodating mechanical/electronic/optic components of the mouse. The top cover has a front portion forming control buttons of the mouse, as well as a control roller. The top cover also has a rear portion having a curved surface from which pegs extend. The pad, which is made of soft and flexible materials, has a bottom corresponding in shape to the curved surface of the cover and positioned on the curved surface with holes defined therein fit over the pegs. The pad may have any desired thickness and different curvatures to fit the need of different users. Patterns/textures may be formed on a surface of the pad. A vibrator is selectively embedded in the pad to massage the palm of a user holding the mouse. The pad can be mounted to mice of different types without affecting functionality thereof.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a computer mouse constructed in accordance with a first embodiment of the present invention;

FIG. 2 is an exploded view of the computer mouse of the present invention;

FIG. 3 is a side elevational view, partly broken, of the computer mouse of the present invention; and

FIG. 4 is a perspective view of a computer mouse constructed in accordance with a second embodiment of the present invention.

### DETAILED DESCRIPTION OF THE PREFERRED EMBODIMENT

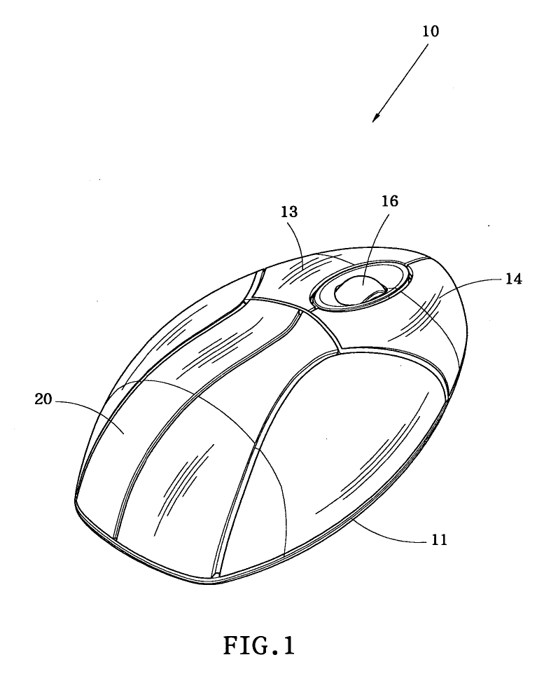

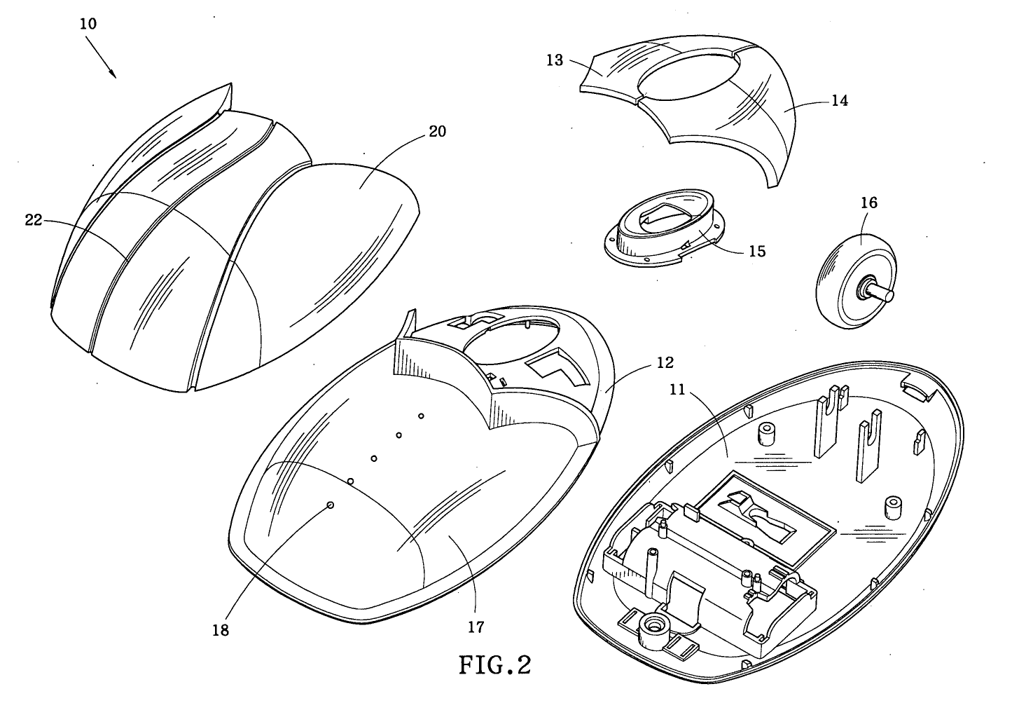

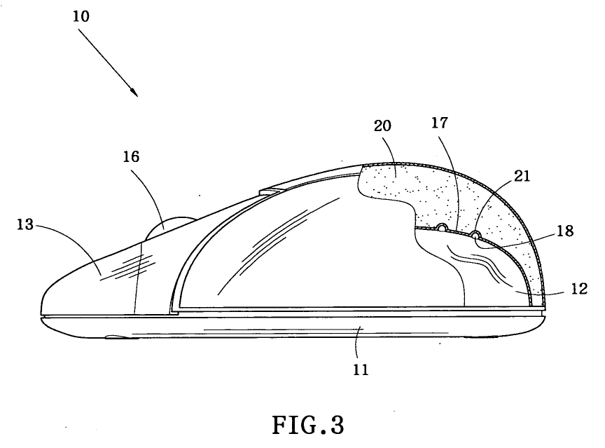

With reference to the drawings and in particular to FIGS. 1-3, a computer mouse constructed in accordance with the present invention, generally designated with reference numeral 10, comprises a body having a bottom 11 that has a flat undersurface for moving on for example a desk (not shown) and a top cover 12 mounted to the bottom 11 to define an interior space therebetween in which mechanical/electronic/optic components of the computer mouse 10 are accommodated. Since the mechanical/electronic/optic components of the computer mouse are generally known to those having ordinary skill in the art and since these parts constitute no novel part of the present invention, no further detail will be given herein.

The top cover 12 has a front portion and a rear portion separated by a partition wall (all not labeled). The front portion forms a left button 13 and a right button 14. If desired, and as shown in the drawings, a roller receptacle 15 is provided between the left and right buttons 13, 14 to rotatably receive a roller 16 that partially projects beyond the top cover 12 through an opening (not labeled) formed between the buttons 13, 14 for user's access.

The rear portion of the top cover 12 has a curved surface 17 on which pegs 18 are formed and extending upward therefrom. A soft pad 20, made of soft and flexible materials, has a bottom having a configuration corresponding to the curved surface 17 of the top cover 12 whereby the pad 20 is tightly fit over the curved surface 17 of the top cover 12. Holes 21 are defined in the bottom of the pad 20, corresponding in position and size to the pegs 18 whereby the holes 21 are fit over the pegs 18 when the pad 20 is positioned on the top cover 12. The engagement between the pegs 18 and the holes 21 secures the pad 20 on the top cover 12 to combine the pad 20 and the body of the mouse 10 together.

It is apparent to those having ordinary skills to replace the peg-hole arrangement with any known fastening means, such as adhesives. It is also apparent to those having ordinary skills to shape the pad 20 as desired to fit the needs of different users, such as changing thickness of the pad and curving the pad 20 with different curvatures, thereby enhancing grippability by the user and improving ergonomic effects. In addition, patterns 22, such as texture, figure, and texts, may be provided on an outside surface of the pad 20 for better grippability and/or decoration.

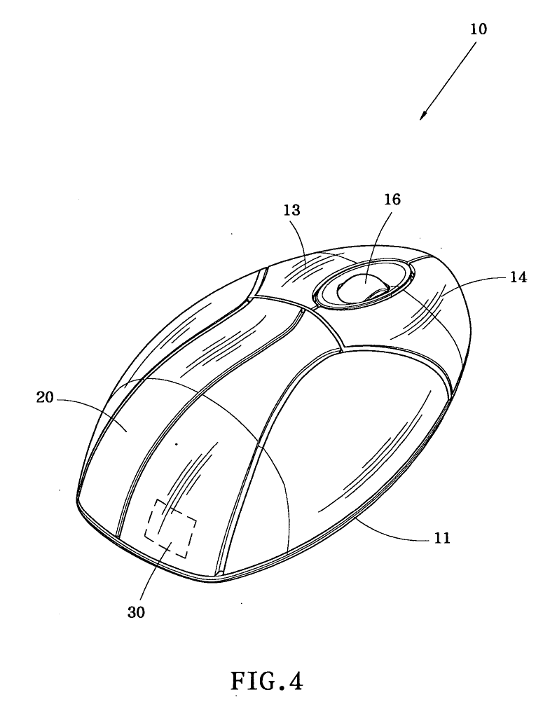

Referring to FIG. 4, if desired, a vibrator 30 can be arranged inside or embedded in the pad 20 of the mouse 10. The vibrator 30 induces vibration of the pad 20, which allows the pad 20 to massage the palm and wrist of the user when the user holds the mouse 10 with his or her palm. An ON/OFF switch (not shown) for the vibrator 30 may be provided for selectively turning on/off the vibrator 30. Or alternatively, a pressure sensor (not shown) arranged inside the pad 20 can be used to actuate the vibrator 30 in response to a gripping force applied to the mouse 10 by a user's palm.

To summarize, the computer mouse in accordance with the present invention provides the computer mouse with better grippability, enhanced ergonomics and comfortable operation of the mouse by adding a soft pad on the top cover of the mouse. In addition, textures or patterns formed on the pad allow easy change of outside appearance of the mouse. Further, the vibrator arranged inside the pad makes the mouse functioning like a hand massager, which certainly adds value to the mouse. Moreover, since the basic structure of a computer mouse does not change in adding the pad to the mouse, the present invention is applicable to all kinds of computer mice without affecting functionality thereof.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A computer mouse comprising:
a body comprising a bottom and a top cover mounted to the bottom to define therebetween an interior space for accommodating mechanical/electronic/optic components, the cover having front and rear portions, the front portions forming control buttons of the mouse, the rear portion having a surface; and
a soft pad attached to the surface of the rear portion of the cover of the mouse.

2. The computer mouse as claimed in claim 1, wherein the surface of the rear portion forms pegs and wherein the pad has a bottom in which holes are defined, the holes being fit over the pegs to retain the pad on the surface of the rear portion.

3. The computer mouse as claimed in claim 1, wherein the surface of the rear portion is curved and wherein the bottom of the pad has a configuration corresponding to the curved surface of the rear portion to allow tight engagement between the pad and the surface of the rear portion.

4. The computer mouse as claimed in claim 1, wherein the pad has an outside surface on which patterns and/or textures are formed.

5. The computer mouse as claimed in claim 1 further comprising a vibrator embedded in the soft pad.
